(19) United States
(12) Patent Application Publication
(10) Pub. No.: US 2026/0289319 A1
(43) Pub. Date: Sep. 24, 2026

(54) PROMPT EVOLUTION AND SELECTION USING DISTRIBUTED NEURAL PROCESSING UNITS

(71) Applicant: Dell Products L.P., Round Rock, TX (US)

(72) Inventors: JEANNIE FITZGERALD, Ennis (IE); ONUR CELEBIOGLU, Austin, TX (US); RUWAN ASANKA WASALA, Limerick (IE)

(21) Appl. No.: 19/085,564

(22) Filed: Mar. 20, 2025

(51) Int. Cl. G06N 3/091

(52) U.S. Cl. CPC G06N 3/091

(57) ABSTRACT

Methods and systems for generating and optimizing large language model (LLM) input prompts are disclosed. Proposed prompts generated by LLMs forming an evolutionary/swarm intelligence group may be evolved using a prompt evolution process involving one or more genetic operators. Optimized prompts may then be selected from the evolved prompts once the evolved prompts meet evolution termination criteria that defines an object measure for the LLMs to determine whether the evolved prompts are optimized, and subsequently used in one or more downstream processes.

### FIELD

Embodiments disclosed herein relate generally to use of neural processing units (NPUs). More particularly, embodiments disclosed herein relate to systems and methods for using idle and/or non-idle resources of NPUs installed across distributed data processing systems (e.g., computing devices) to perform evolutionary prompt (e.g., large language model (LLM) prompts, or the like) optimization.

### BACKGROUND

Computing devices may provide computer implemented services. The computer implemented services may be used by users of the computing devices and/or devices operably connected to the computing devices. The computer implemented services may be performed with hardware components such as processors, memory modules, storage devices, and communication devices. The operation of these components and the components of other devices may impact the performance of the computer implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with one or more embodiments.

FIG. 1B shows a block diagram illustrating a data processing system in accordance with one or more embodiments.

FIG. 1C shows a data flow diagram in accordance with one or more embodiments.

FIG. 2A shows a data flow diagram in accordance with one or more embodiments.

FIG. 2B shows a flowchart in accordance with one or more embodiments.

FIG. 2C shows an implementation example in accordance with one or more embodiments.

FIG. 3 shows a flowchart in accordance with one or more embodiments.

FIG. 4 shows a block diagram illustrating a computing device in accordance with one or more embodiments.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

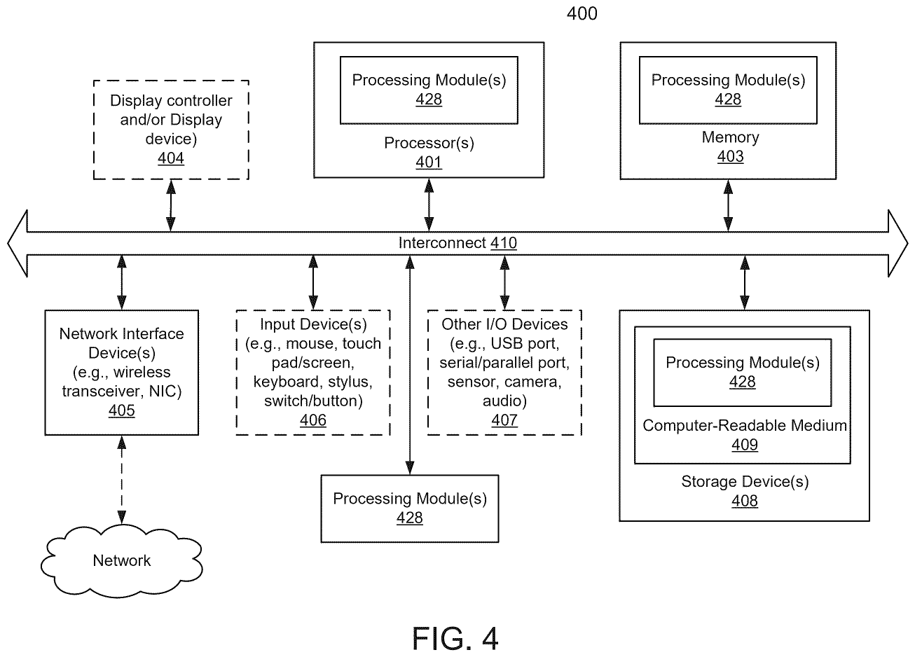

In general, embodiments disclosed herein relate to methods and systems for performing prompt evolution and selection (e.g., optimization) using idle (and/or non-idle) resources of one or more on-device neural processing units (NPUs) of data processing systems (e.g., computing devices, as described below in reference to FIG. 4) across a distributed system.

As artificial intelligence (AI) based technologies continue to advance, special processing units (e.g., graphical processing units (GPUs), NPUs, or similar computer chips) dedicated for AI tasks (e.g., machine learning/AI model training, machine learning/AI model execution, or the like) are developed to ease the burden on existing computing processing units (CPUs) of data processing systems.

For example, an NPU is a dedicated processor or processing unit on a larger system on a chip (SoC) designed specifically for accelerating neural network operations and AI tasks. Unlike general-purpose CPUs and GPUs, NPUs are optimized for a data-driven parallel computing, making them highly efficient at processing massive multimedia data like videos and images and processing data for neural networks. They are particularly adept at handling AI-related tasks, such as speech recognition, background blurring in video calls, and photo or video editing processes like object detection. Additionally, NPUs are integrated circuits but they differ from single-function ASICs (Application-Specific Integrated Circuits). While ASICs are designed for a singular purpose (such as mining bitcoin), NPUs offer more complexity and flexibility, catering to the diverse demands of network computing. They achieve this through specialized programming in software or hardware, tailored to the unique requirements of neural network computations.

In some cases (e.g., in consumer based electronic cases or the like), an NPU may be integrated into the main CPU of a data processing system while in other cases (e.g., at larger data centers or more specialized industrial operations or the like), the NPU might be an entirely discrete processor (e.g., separate from any other processing units) installed on a motherboard of the data processing system.

Neuroevolution is a method for modifying neural network weights, topologies, and/or ensembles in order to learn a specific task. One example of neuroevolutionary, evolutionary computation, is used to search for network parameters that maximize a fitness function that measures performance in the task. Compared to other neural network learning methods, neuroevolution is highly general, allowing learning without explicit targets, with non differentiable activation functions, and with recurrent networks. Neuroevolution can also be advantageously combined with standard neural network learning (e.g. with biological adaptation) and/or with deep learning capabilities of NPUs. In particular, because NPUs are specifically designed to process deep learning workloads, NPUS are generally more suited (than CPUs, GPUs, or the like) for empirical tasks involving deep learning algorithms and their architectures (e.g., neuroevolution-based tasks). Neuroevolution can also be seen as a policy search method for reinforcement-learning problems, where it is well suited to continuous domains and to domains where the state is only partially observable.

Additionally, since NPUs are specifically designed to implement AI related tasks, an NPU of a data processing system may have more idle time than the CPU of the same data processing system. In particular, while no AI related tasks are being implemented or scheduled, the CPU may be busy executing other processes (e.g., the operating system, non-AI related applications, or the like) while the NPU sits idle. While the NPU sits idle, the computing resources of the idle NPU sits wasted.

Furthermore, because NPUs are much more expensive and more difficult to obtain than CPUs and GPUs, more effective use of these NPUs is generally desired than to let these NPUs sit idle and go to waste. Thus, embodiments disclosed herein utilize such idle periods of NPUs for execution of tasks that users and/or data processing system may not need but could find helpful (e.g., helpful for the user and helpful for improving the functionalities of the data processing system).

One such task includes the optimization of prompts (e.g., LLM prompts, search query based prompts, or the like). In particular, in the current era (e.g., technological state) where prompt generation and optimization are still a human based activities that heavily leverage an iterative trial and error approach (e.g., as evidenced by the emergence of the new role of “prompt engineer” and the plethora of prompt engineering “best practices”, “tips and tricks”, and “step by step” articles and knowledge bases being established and shared on a daily basis in the AI/machine learning space), there is a long-felt need of moving prompt generation and optimization away from the heavy reliance on a human actor. Namely, prompt generation and optimization are very time consuming and inexact activities that are not necessarily better when performed by humans, leading to a slower growth in the development and improvement of generative pre-trained transformer (GPT) based models such as Chat-GPT, Deepseek, or the like.

Embodiments herein leverage advantages of both large language models (LLMs) and evolutionary computing to resolve such long-felt need for moving prompt generation and optimization away from the heavy reliance on a human actor.

In particular, evolutionary computation (EC) is an AI/ML approach that is effective for finding optimal/near-optimal solutions in large, potentially infinite search spaces. EC is distinguished from other AI/ML methods by its biological inspiration and adoption of Darwinian principles of evolution where the fittest survive and have a greater opportunity to reproduce, resulting in the advantageous passage of superior genetic materials future generations. Furthermore, mutations may occur from time to time with EC, which may advantageously introduce useful new genetic material leading to even more measurable improvements. Essentially, EC involves parallel, guided random search of the problem space, where the “guided” aspect is implemented using algorithms that are influenced by ideas associated with the improvements (e.g., genetic improvements, and the like) experienced by biological evolution.

Furthermore, LLMs have shown remarkable efficiency in Natural Language Processing (NLP) tasks including interpreting machine generated data into formats comprehensible to humans. Thus, embodiments disclosed herein combine LLMs (and/or other similar types of AI/machine learning models) with EC based techniques to deliver an automated solution for prompt generation and optimization where prompts that are optimal/near-optimal in terms of some user-defined measurable success metric may be obtained without any human involvement within the process (except during, e.g., prompt input by a user).

More specifically, embodiments disclosed herein advantageously leverage distributed LLMs together with a parallel search algorithm, enabling evolution of effective prompts many times faster than prompts generated through human based trial and error processes. In particular, once the task (e.g., prompt generation task) and evaluation metrics have been defined and submitted to the LLMs, no further human intervention is required until the one or more optimized prompts (e.g., optimized against the evaluation metrics and task details) are provided.

Furthermore, the above-discussed computing resources of idle NPUs (also referred to herein as “idle NPU resources”) may advantageously be utilized, using processes and methods associated with embodiments disclosed herein, to better utilize potentially underutilized resources of these data processing systems.

As a result, embodiments disclosed herein may improve computer-related technology (e.g., AI/machine learning based technologies such as generative pre-trained transformer (GPT) based model training and refinement, or the like) by resolving the long-felt need of removing the human element from conventional prompt generation and optimization processes. In particular, the time consuming and inexact aspects of prompt generation and optimization associated with the involvement of a human (e.g., a prompt engineer or the like) may be resolved and improved upon through the removal of such human involvement.

Even further, embodiments disclosed herein may directly improve all fields of computing-related technology as a whole and further improve the functionalities and operations of a computing device. In particular, the disadvantages and limits associated with underutilization of idle NPU resources may be overcome and resolved using the processes and methods of embodiments disclosed herein, thus leading to a more effective use and improved operations of computing devices that host one or more NPUs.

Other advantages, improvements to various computer-related technologies and improvements to computer functionalities will be apparent below as more details regarding embodiment disclosed here are described.

In an embodiment, a method for generating optimized prompts may include: obtaining a first prompt optimization request comprising a first task description and a first evolution termination criteria; causing one or more trained machine learning models to generate a first prompt population for the first prompt optimization request, the first prompt population for the first prompt optimization request comprising first-generation prompts based on the first task description and each of the first-generation prompts comprising a prompt fitness score; making a first determination that the first prompt population for the first prompt optimization request fails to meet the first evolution termination criteria; performing, in response to the first determination, a prompt evolution process on the first prompt population for the first prompt optimization request to obtain a second prompt population for the first prompt optimization request, the second prompt population for the first prompt optimization request comprising second-generation prompts based on the first-generation prompts and each of the second-generation prompts comprises the prompt fitness score; making a second determination that the second prompt population for the first prompt optimization request meets the first evolution termination criteria; selecting, in response to the second determination, at least one of the second-generation prompts of the second prompt population for the first prompt optimization request as an optimized prompt for the first prompt optimization request; and using the optimized prompt for the first prompt optimization request to fulfill the first prompt optimization request.

The method may further include: obtaining a second prompt optimization request comprising a second task description and a second evolution termination criteria; causing the one or more trained machine learning models to generate the first prompt population for the second prompt optimization request, the first prompt population for the second prompt optimization request comprising first-generation prompts based on the second task description and each of the first-generation prompts comprising the prompt fitness score; making a third determination that the first prompt population for the second prompt optimization request meets the second evolution termination criteria; selecting, in response to the third determination, at least one of the first-generation prompts of the first prompt population for the second prompt optimization request as an optimized prompt for the second prompt optimization request; and using the optimized prompt for the second prompt optimization request to fulfill the first prompt optimization request.

The first prompt population of the first prompt optimization request is generated using idle neural processing unit (NPU) resources of one or more data processing systems on which the one or more trained machine learning models are respectively hosted, the idle NPU resources are associated with at least one NPU of each of the one or more data processing systems, and the at least one NPU of each of the data processing systems is separate from a central processing unit (CPU) of each of the data processing systems.

The first prompt population of the first prompt optimization request is generated using idle neural processing unit (NPU) resources of one or more data processing systems on which the one or more trained machine learning models are respectively hosted, the idle NPU resources are associated with at least one NPU of each of the one or more data processing systems, and the at least one NPU of each of the data processing systems is separate from a central processing unit (CPU) of each of the data processing systems.

Performing the prompt evolution process on the first prompt population may include: selecting at least one of the first-generation prompts based on the prompt fitness score of the at least one of the first-generation prompts that is selected; and performing a genetic operation on the at least one of the first-generation prompts that is selected to obtain at least one of the second-generation prompts.

The genetic operation comprises a direct selection of the at least one of the first-generation prompts to be used as-is as the at least one of the second-generation prompts that is obtained.

The genetic operation comprises a mutation of at least one portion of the at least one of the first-generation prompts into the at least one of the second-generation prompts.

The genetic operation comprises a crossover of the at least one of the first-generation prompts with another one of the first-generation prompts to obtain the at least one of the second-generation prompts as an offspring of the at least one of the first-generation prompts and the other one of the first-generation prompts.

Instances of the genetic operation are performed repeatedly on different ones of the first-generation prompts until a predetermined population number is reached for the second prompt population for the first prompt optimization.

Using the optimized prompt for the first prompt optimization request to fulfill the first prompt optimization request may include: ingesting the optimized prompt for the first prompt optimization request into at least one of the one or more trained machine learning models to generate a query response based on the optimized prompt for the first prompt optimization request, the query response being responsive to a query input by a user and the first prompt optimization request being generated based on the query; and providing the query response to the user along with the optimized prompt for the first prompt optimization request.

A non-transitory media may include instructions that when executed by at least a processor of a data processing system cause the computer-implemented method to be performed by the data processing system.

A data processing system may include the non-transitory media and a processor, and may perform the computer-implemented method when processor executes the instructions in the non-transitory media.

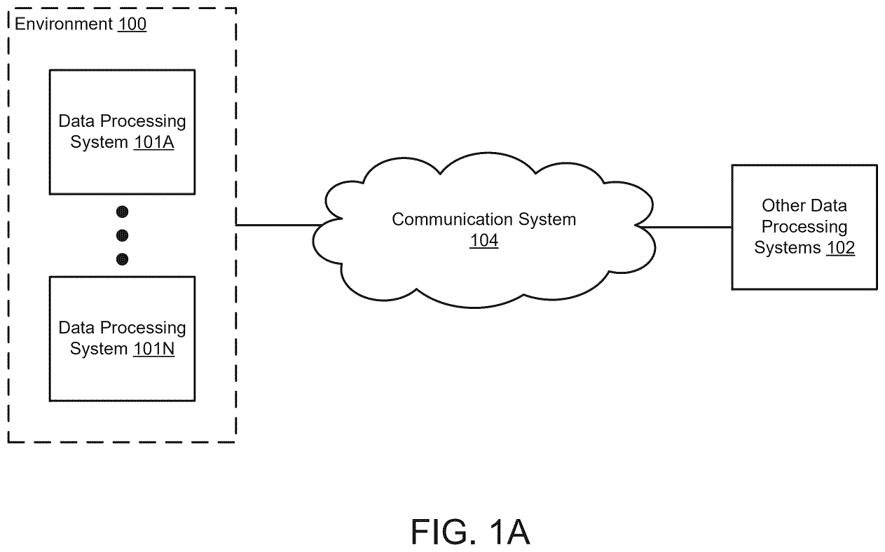

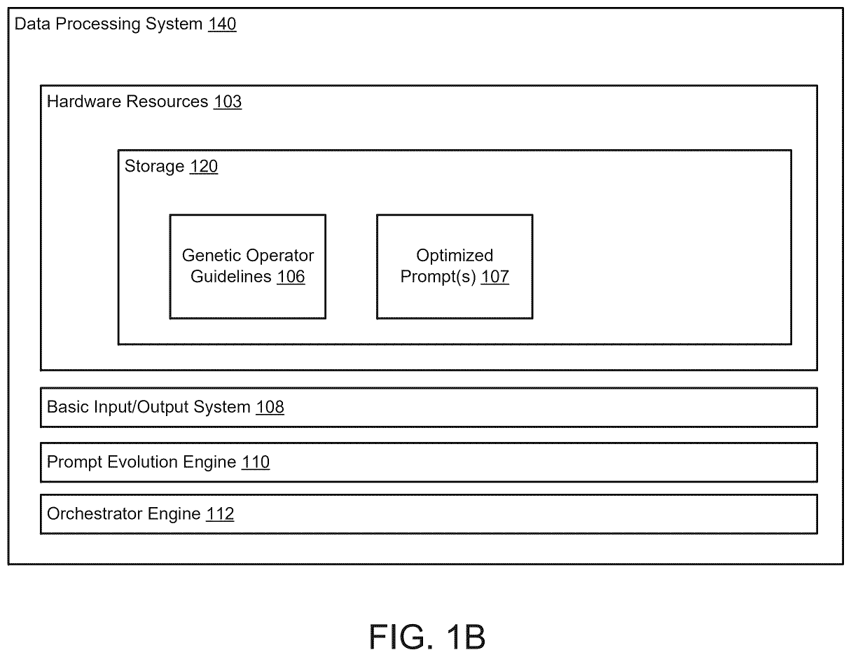

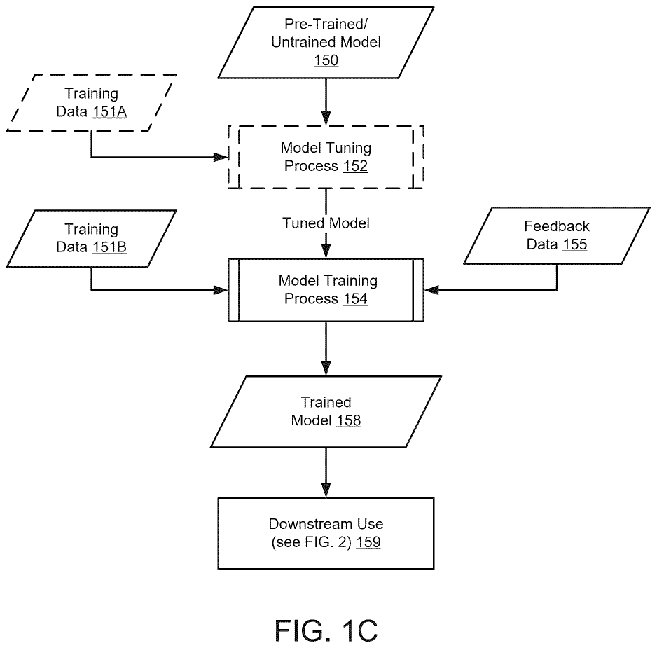

Turning to FIG. 1A, a block diagram illustrating a system in accordance with an embodiment is shown. The system shown in FIG. 1A may provide computer implemented services. The computer implemented services may include any type and quantity of computer implemented services. For example, the computer implemented services may include data storage services, instant messaging services, database services, AI/ML services and/or any other type of service that may be implemented with a computing device.

To provide the above noted functionality, the system of FIG. 1A may include any number of data processing systems 101A-101N that make up a computing environment 100. Computing environment 100 may be any type of environment (e.g., a deployment, a remote server, a corporation's office, a single user, a distributed system, or the like) where one or more of the data processing systems 101A-101N may be hosted and used to provide computer implemented services to one or more users.

Each data processing system 101A-101N may be a node within the computing environment 100. One or more nodes may then be combined and/or arranged into one or more clusters (e.g., one or more groups of data processing systems), each of which having at least one of the nodes. Additionally, data processing systems 101A-101N may provide the computer implemented services to users of data processing systems 101A-101N and/or to other devices (not shown). Different data processing systems may provide similar and/or different computer implemented services.

To provide the computer implemented services, data processing systems 101A-101N may include various hardware components (e.g., various types of processors, memory modules, storage devices, etc.) and host various software components (e.g., operating systems, application, machine learning model, startup managers such as basic input-output systems, etc.). These hardware and software components (discussed in more detail below in FIG. 1B) may provide the computer implemented services via their operation.

The software components may be implemented using various types of services. For example, each data processing system of the data processing systems 101A-101N may host various services that provide the computer implemented service (e.g., application services, data anonymization services, data verification services, or the like) and/or that manage the operation of these services (e.g., management services). The aggregate (e.g., combination) of the management and application services may be a complete service that provide desired functionalities.

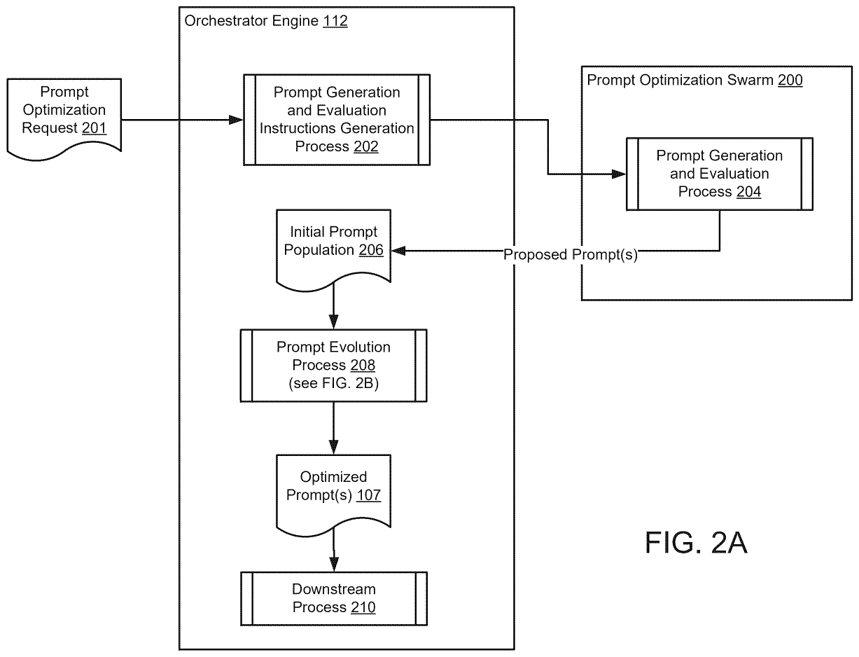

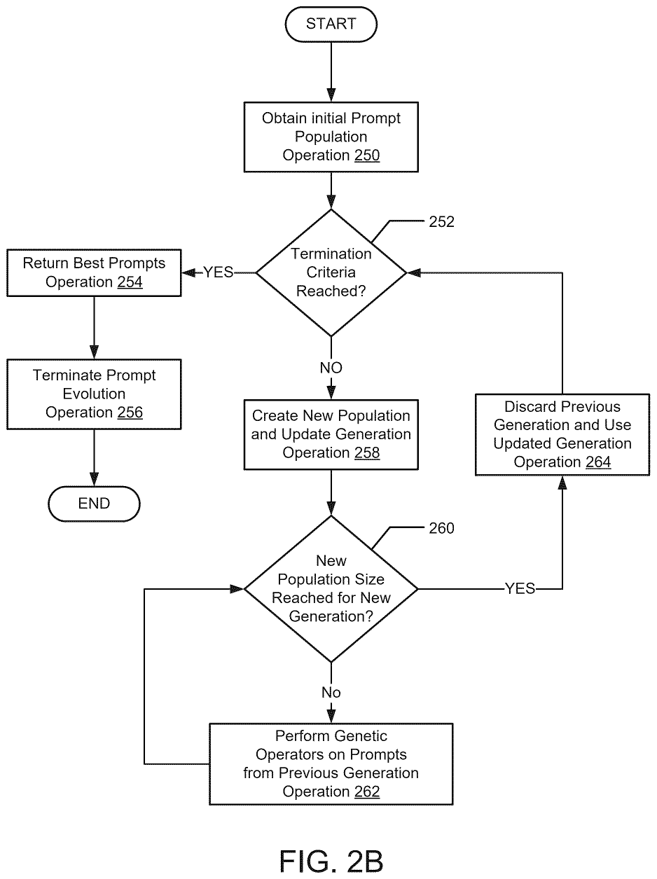

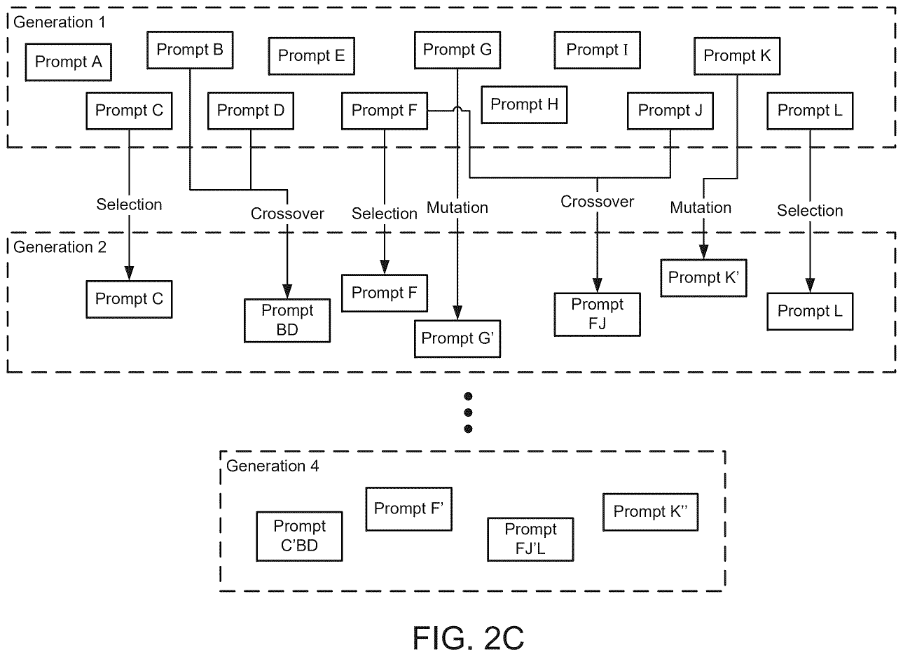

Any of the components illustrated in FIG. 1A may be operably connected to each other (and/or components not illustrated) with communication system 104. In an embodiment, communication system 104 includes one or more networks that facilitate communication between any number of components (e.g., computing environment 100 with other data processing systems 102 making up other environments over the network). The networks may include wired networks and/or wireless networks (e.g., and/or the Internet). The networks may operate in accordance with any number and types of communication protocols (e.g., such as the Internet Protocol). For example, the data processing systems 101A-101N may be combined with the other data processing systems 102 to create an even larger distributed system with even better capabilities for evolutionary/swarm intelligence techniques (as discussed in more detail below in FIGS. 2A-2B).

In embodiments, within the computing environment 100, the data processing systems 101A-101N may be connected via a local area network (LAN) based protocol to form an intranet setting between the data processing systems 101A-101N.

While FIG. 1A is illustrated as including a limited number of specific components, a system in accordance with an embodiment may include fewer, additional, and/or different components than those illustrated therein.

Turning to FIG. 1B, a diagram illustrating data processing system 140 in accordance with an embodiment is shown. Data processing system 140 may be similar to any of the data processing systems 101A-101N and/or any of the other data processing systems 102 shown in FIG. 1A.

To provide computer implemented services (e.g., prompt generation services, prompt optimization services, prompt execution services, and/or services associated with any of the processes and/or methods discussed below in reference to FIGS. 1C-2B, or the like), data processing system 140 may include any quantity of hardware resources 103. Hardware resources 103 may include physical parts of data processing system 140 that store and run software. Hardware resources 103 may include processors (e.g., CPUs, GPUs, NPUs), memory modules (also referred to herein as “memory devices”), storage devices, and/or other types of hardware components usable to provide computer implemented services. A basic input/output system (BIOS) 108 may be stored on the processors and memory modules.

Storage 120 may be implemented using any combination of storage devices (e.g., hard disk drives (HDDs), solid state drives (SSDs), volatile memory, non-volatile memory, or the like). Storage 120 may be configured to store at least genetic operator guidelines 106 and optimized prompt(s) 107.

In embodiments, genetic operator guidelines 106 may include guidelines (e.g., one or more sets of object rules, policies, templates, instructions, commands, logic, targets, or the like) that are pre-defined and/or pre-set by one or more users (e.g., owners, administrators, or the like) of data processing system 140. These guidelines are followed when one or more genetic operators (which are discussed in more detail below in reference to FIGS. 2A-2B) are employed (e.g., executed) during a prompt evolution process of one or more embodiments.

In embodiments, optimized prompt(s) 107 are one or more optimal and/or near-optimal prompts generated using the prompt evolution process of one or more embodiments, with the determination of the prompts being optimal and/or near-optimal being based on a set of user-provided, clearly defined, objective, measurable success metrics such as the evolution termination criteria discussed herein.

BIOS 108 may be used to startup data processing system 140. On the startup, BIOS 108 may configure peripheral devices, such as a keyboard, mouse, monitor, etc. With the peripheral devices, BIOS 108 may configure hardware resources 103 for use by data processing system 140.

Prompt evolution engine 110 may be implemented using hardware, software, or a combination thereof. For example, prompt evolution engine 110 may be configured using and/or configured to host one or more large language models (LLMs) (also referred to herein as “prompt evolution LLMs”). The prompt evolution LLMs may be hosted on an NPU making up the hardware resources 103 of the data processing system 140. The prompt evolution LLMs may be specifically configured (e.g., instantiated and trained) as LLMs for: (i) generating one or more prompts; (ii) evaluating one or more prompts; and/or (iii) performing the prompt evolution process of one or more embodiments disclosed herein. Functions and training of the prompt evolution LLMs of the prompt evolution engine 110 are discussed in more detail below in reference to FIGS. 1C through 2B.

Orchestrator engine 112 may be implemented using hardware, software, or a combination thereof. For example, orchestrator engine 112 may be configured to manage the prompt evolution process of one or more embodiments performed by the prompt evolution engine 110 of data processing system in combination with prompt evolution engines 110 of other data processing systems that make up an environment (e.g., 100, FIG. 1A) and/or distributed system. Said another way, the orchestrator engine 112 may be configured as a manager of one or more prompt evolution engines 110. Orchestrator engine 112 may also employ one or more NPU bidding and/or arbitration based techniques.

In embodiments, not every data processing system (e.g., 101A-101N, FIG. 1A) within an environment (e.g., 100, FIG. 1A) may include the orchestrator engine 112. For example, only one (or a sub-portion of) the data processing systems within an environment may include the orchestrator engine 110. Alternatively, in some embodiments, every data processing system within an environment may include orchestrator engine 112.

Additionally, although the prompt evolution engine 110 and orchestrator engine 112 are shown as two separate components in FIG. 1B, in some embodiments, the prompt evolution engine 110 and orchestrator engine 112 may be combined into a single component having functionalities of both the prompt evolution engine 110 and orchestrator engine 112.

Furthermore, in embodiments, the prompt evolution process may be performed on-device within a single data processing system 140 and/or within multiple data processing systems 140 connected via an intranet environment without utilizing any remote network resources (e.g., a remote server on the network, or the like). The on-device prompt evolution process may be performed when the NPUs of the data processing system(s) 140 are indicated (e.g., via a status label, via a work queue of the NPU(s), or the like) to be idle. Said another way, the NPUs are determined (e.g., by the data processing system 140) to be idle when the data processing system 140 assess that there is nothing for the NPU to do within a predetermined period of time (e.g., 30 minutes, 1 hour, etc.) and/or if a status of an NPU indicates that it is currently idle.

Once an NPU is determined to be idle (or even partially idle with some NPU resources being labeled as idle while other NPU resources of the same NPU are executing other AI tasks), the resources of these idle NPUs (or partially idle NPUs) may be configured by the data processing system 140 (e.g., via instructions/commands from the CPU, the NPU's independent processor core, or the like) to start performing the prompt evolution process to start (e.g., essentially as a background process of the NPUs) generating one or more optimized prompts 107. This advantageously utilizes idle NPU resources that would have otherwise gone to waste as the NPUs sit idle, which directly improves the functionalities and operations of these NPUs hosted by the data processing systems.

Further, since NPUs are specifically designed for AI tasks and are more cumbersome (or even simply not designed) to be used for non-AI tasks (e.g., graphics processing similar to GPUs and operating system management similar to CPUs), ensuring that none of the NPUs become idle or stay in the idle state for too long advantageously provides a more effective/efficient use of these NPUs.

Additionally, the on-device prompt evolution process (e.g., via a single computing device or within an intranet setting) advantageously avoids any negative impacts (e.g., delays resulting from network latency, data loss, or the like) associated with transmission of data over a network (e.g., transmitting one or more non-optimized prompts and/or optimized prompts 107 over a network). Furthermore, the approach of using idle NPU resources also advantageously leverages energy-efficient processing based on cycle harvesting techniques.

While FIG. 1B is illustrated as including a limited number of specific components, a data processing system in accordance with an embodiment may include fewer, additional, and/or different components than those illustrated therein. For example, in addition to all of the components shown in FIG. 1B, the data processing system 140 may also include part of all of the components of the example computing device described below in reference to FIG. 4.

Turning now to FIG. 1C, FIG. 1C shows a data flow diagram illustrating a process for instantiating and training the prompt evolution LLM(s) of the prompt evolution engine 110. In the data flow diagram of FIG. 1C, components and data (e.g., trained or untrained models, time-series data, or the like) are shown using a first set of shapes (e.g., 150, 151A, 151B, 155, 158, etc.), processes using the data and/or components are shown using a second set of shapes (e.g., 152, 154), and uses of the data and/or components are shown using a third set of shapes (e.g., 159).

As shown in FIG. 1C, a pre-trained/untrained model 150 may first be obtained. The pre-trained/untrained model 150 may be an LLM that has not yet been configured (e.g., trained) for any specific tasks and/or has been minimally configured (e.g., with the necessary libraries, etc.) to perform a specific function (namely, in the context of embodiments disclosed herein, the pre-trained/untrained model 150 may be minimally configured for prompt generation and prompt evaluation).

In embodiments, the pre-trained/untrained model 150 may be obtained from any source without departing from the scope of embodiments disclosed herein. In one example, the pre-trained/untrained model 150 may be created by the entity associated with environment 100 (e.g., of FIG. 1A) using propriety code and/or open-source code. In another example, the pre-trained/untrained model 150 may be downloaded from the network (e.g., the Internet) from one or more online developer's website (e.g., in the form of an LLM template/base LLM model).

The pre-trained/untrained model 150 may be ingested into model tuning process 152 along with training data 151A where one or more AI/ML related techniques may be used to pre-train and/or fine-tune the pre-trained/untrained model 150. For example, the pre-trained/untrained model 150 may be pre-trained using a diverse array of training data including, but not limited to: raw sensor data, telemetry (e.g., of data processing system 140), event logs/system logs, application logs, published data retrieved from one or more public sources such as the Internet or physical books that are digitized (e.g., web text corpora with mostly user-generated content), or the like. Such pre-training may advantageously expand the pre-trained/untrained model 150 vocabulary and tokens, thereby equipping the pre-trained/untrained model 150 with the capacity to understand and process a wide range of data and information during the prompt evolution process of one or more embodiments.

Unlike existing training protocols where pre-trained/untrained models are trained solely on web text corpora with mostly user-generated content, such pre-training using (e.g., raw) raw sensor/telemetry data advantageously enables the pre-trained/untrained model 150 to obtain a deeper and more detailed understanding of data of such types. This is an improvement over conventional/traditional model pre-training processes in that the resulting tuned model generated from model tuning process 152 would be more easily adaptable to real-world application and environments where data is unstructured and not pre-treated/processed (e.g., less synthetic and more natural than) like the traditional user-generated content used in model-pretraining.

Once the pre-trained/untrained model 150 is pre-trained, the pre-trained model may be fine-tuned (e.g., further trained) using sample prompt generation based data (e.g., prompt templates, sample prompts, existing prompts, or the like). In particular, such fine-tuning may include human-annotated data that helps the pre-trained model more accurately identify the most relevant and important information (e.g., critical alerts, errors, warnings, key events, key words, etc.) from within the prompts while also filtering out any non-related, less-useful, sensitive, and/or proprietary information from within one or more given prompts (e.g., user inputs). Said another way, the model fine-tuning utilizes annotated data to help the pre-trained model better understand and evaluate one or more given and/or generated prompts.

Other LLM training techniques/protocols not discussed above that achieve the same effects/results may also be used as part of any of the model tuning process 152 without departing from the scope of embodiments disclosed herein.

Once fine-tuned, a tuned model may be obtained. Once the tuned model is obtained, the tuned model may (as discussed above) be ingested into model training process to be trained against training data 151B and feedback data 155. In embodiments, training data 151B may include examples of previously generated prompts and user feedback (e.g., evaluations) associated with such generated prompts, or the like). Feedback data 155 may include user feedback (e.g., evaluations) associated with one or more prompts generated by the tuned model. Said another way, the tuned model is trained to generate its own prompts and trained to be able to evaluate (e.g., score) the prompts it generates using the combination of the training data 151B and the feedback data 155.

In embodiments, the model training process 154 may utilize any type and combination of AI/ML related training techniques such as Deep Reinforcement Learning (DRL) based techniques, Reinforcement Learning from Human Feedback (RLHF), or the like. In embodiments, the training data 151B may also include the genetic operator guidelines 106 as discussed in reference to FIG. 1B. Additionally, model training process 154 may be repeated (e.g., the trained model being retrained) whenever new training data 151B and/or feedback data 155 are received.

Once the tuned model has been trained using model training process 154, trained model 158 may be obtained. Once obtained, trained model 158 may be applied to one or more downstream uses (e.g., used in the machine generated data conversion processes of embodiments disclosed herein). Such downstream uses are further discussed below in reference to FIGS. 2A-2B.

In embodiments, the model training process shown in FIG. 1C may be performed by the data processing system 140 hosting the prompt evolution engine 110. Alternatively, the model training process shown in FIG. 1C may be performed may be performed by a separate computing device (e.g., any other data processing system) with the trained model 158 then being provided (e.g., transmitted) to be hosted by the data processing system 140 using the prompt evolution engine 110 (e.g., as a dynamically updated mirror copy of the trained model 158 that is continuously updated and further refined on the separate data processing system). For example, each time the trained model 158 is updated on the separate computing device, the data processing system 140 hosting the prompt evolution engine 110 will also receive (e.g., as a mirror copy) the updated version of the trained model 158. In embodiments, any of the model trainings steps discussed in FIG. 1C may be performed using supervised learning techniques, unsupervised learning techniques, or a combination thereof.

To further clarify embodiments disclosed herein, a data flow diagram in accordance with embodiments disclosed herein is shown in FIG. 2A, a flow chart in accordance with embodiments disclosed herein is shown in FIG. 2B, and an implementation example in accordance with embodiments disclosed herein is shown in FIG. 2C. In particular, FIGS. 2A and 2B show a prompt optimization process of embodiments disclosed herein that utilizes prompt evolution based on EC techniques.

Starting with FIG. 2A, in the data flow diagram of FIG. 2A, flows of data and processing of data are illustrated using different sets of shapes. A first set of shapes (e.g., 201, 206, 107, etc.) is used to represent data structures (e.g., files, documents, data packets, or the like), a second set of shapes (e.g., 202, 204, 208, etc.) is used to represent processes performed using and/or that generate data, and a third set of shapes (e.g., 112, 200, etc.) is used to components and/or devices that perform (e.g., execute) the processes shown using the second set of shapes.

As shown in FIG. 2A, the data flow diagram comprises a prompt optimization swarm 200. This prompt optimization swarm may be made up of one or more of the prompt evolution engines 110 of various data processing systems (e.g., 101A-101N) forming an environment and/or a distributed network. Such a prompt optimization swarm 200 utilizes these one or more prompt evolution engines 110 in an evolutionary/swarm intelligence manner. Said another way, embodiments disclosed herein leverage a swarm of LLMs (and their respective agents (e.g., application programming interfaces (APIs), or the like) together with evolutionary/swarm intelligence algorithm (e.g., the below discussed prompt evolution process 20) such ass genetic algorithm genetic programming, grammatical evolution, or the like, to learn and generate one or more optimized prompt(s) 107.

Such use of the prompt optimization swarm 200 (e.g., made up of both individual, local, and/or network groups of NPUs hosting prompt optimization engines 110) advantageously provides an ensemble learning based technique/process on AI/ML related task (e.g., the prompt generation and evolution processes). Such ensemble learning provides the advantageous benefits and improvements of: (i) reduced overfitting; (ii) faster processing; and the like. In particular, different NPUs of different data processing systems may work on different bootstrap samples of data (e.g., prompts). Different NPUs or groups of NPUs of different data processing systems may also be trained and tested using different AI/ML evolutionary/swarm (e.g., bio and non-bio inspired) algorithms. Finally, hyperparameter tuning (e.g., during model tuning process 152 and/or model training process 154) may also be advantageously distributed across the different NPUs making up the prompt optimization swarm 200.

Turning back to FIG. 2A, prompt optimization request 201 may be obtained by orchestrator engine 112. Prompt optimization request 201 may include: (i) a textual description of a task (e.g., a prompt generation and optimization task); (ii) input examples that may be used in one or more generated prompts; (iii) and a set of evaluation method/metrics (also referred to herein as “evolution termination criteria”).

In embodiments, the textual description of the task may include a query (e.g., prompt) input by a user. For example, the textual description of the task may be “I want CPU power information”, which may be a less optimized way of asking for CPU utilization and/or available CPU resources by a less technically savvy individual. In another example, the textual description of the task may include an interpretation (e.g., a natural language processing (NLP) based) interpretation of a user's input (e.g., query). More specifically, using the “I want CPU power information” input example, the data processing system 140 (e.g., using one or more applications executed by the CPU or using orchestrator engine 112) may analyze and parse this “I want CPU power information” to generate a description of, e.g., “User wishes to retrieve CPU information, generate one or more optimized prompts to execute or present back to the user,” which will be utilized by the orchestrator engine 112 as instructions for starting the prompt generation and optimization process of embodiments disclosed herein.

In embodiments, input examples may be examples of the user's input (in alternate forms) that are provided by the user and/or generated by the data processing system 140 using one or more NLP based techniques (or even retrieved from storage 120 of a data processing system 140, e.g., from any stored training data 151A or 151B). The input examples may be provided in any form (e.g., in complete prose, in a group of key words strung together, or the like) and be of any length without departing from the scope of embodiments disclosed herein.

In embodiments, the evolution termination criteria may include any type of user-provided, clearly defined, objective, measurable success metrics. More specifically, the evolution termination criteria may include any type of metrics that would help the orchestrator engine 112 and/or prompt evolution engine 110 understand when the optimal/near-optimal prompt(s) have been generated and when the prompt evolution process 208 should be terminated in view of this result being achieved. Examples of the evolution termination criteria may include, but is not limited to, any combination of: (i) a generation metric, expressed in the form of a positive integer, indicating how many generations need to have passed for the prompt evolution process 208 to be terminated; (ii) a fitness score threshold indicating a required fitness score value to be met before the prompt evolution process 208 cab be terminated; (iii) a number of prompts each generation of prompts must include; (iv) any number and/or types of genetic operators that need to be executed (e.g., performed) during the prompt evolution process 208) within any specific generation of prompts; or the like.

Other types of metrics that would help the orchestrator engine 112 and prompt evolution engine 110 better understand when one or more user-defined needs are met may be included as part of the evolution termination criteria included in the prompt optimization request. Additionally, the evolution termination criteria may be defined by the user that provided the input that was used as the basis of the prompt optimization request 201, may be a predefined set of metrics that are prestored in the data processing system 140, and/or may be added and/or configured by an administrator of the environment 100.

Upon receiving the prompt optimization request 201, the orchestrator engine 112 may parse the prompt optimization request 201 and generate prompt generation instructions based on the contents of the prompt optimization request 201 (e.g., as part of prompt generation and evaluation instructions generation process 202). The orchestrator engine 112 may generate any number of prompt generation instructions (e.g., based on a population requirement specified in the evolution termination criteria of the prompt optimization request, based on one or more predefined instruction generation guidelines, based on how many prompt evolution engines 110 make up the prompt optimization swarm 200, based on how many prompt evolution engines 110 within the prompt optimization swarm 200 are available (e.g., have the available NPU resources) to execute the prompt generation instructions, based on how many of the prompt evolution engines 110 within the prompt optimization swarm 200, or the like).

In embodiments, prompt generation instructions may cause a prompt evolution engine 110 (that received the instructions and as part of prompt generation and evaluation process 204) to use the prompt evolution LLM top generate a proposed prompt and execute the proposed prompt against itself (e.g., in a self-grading manner, self-evaluation manner using the data on which the prompt evolution LMM was trained) to determine (e.g., calculate) a result/fitness score for the proposed prompt. The fitness score may indicate how closely the prompt evolution LLM believes the proposed prompt it generated resolves the query included in the user's input. In embodiments, the fitness score may be calculated and represented in any way (e.g., a score out of 100 or the like) without departing from the scope of embodiments disclosed herein.

Once all of the prompt evolution engines 110, within the prompt optimization swarm 200, that has received the prompt generation instructions from the orchestrator engine 112 has generated and evaluated a proposed prompt, all of the generated and evaluated proposed prompts are provided (e.g., transmitted, sent, or the like) back to the orchestrator engine 112 where the set of generated and evaluated proposed prompts are compiled by the orchestrator engine 112 into an initial prompt population (also referred to herein as “a first prompt population having first-generation prompts”).

The initial prompt population 206 containing the first prompt population with the first-generation prompts are then ingested into prompt evolution process 208. To illustrate prompt evolution process 208, a flowchart of embodiments disclosed herein is provided in FIG. 2B. Any of the orchestrator engine 112 and/or the prompt evolution engines 110 (making up the prompt optimization swarm 200) may perform all or a portion of the methods shown in the flowchart of FIG. 2B. In the diagrams discussed below and shown in FIG. 2B, any of the operations may be repeated, performed in different orders, and/or performed in parallel with or in a partially overlapping in time manner with other operations.

Starting at Operation 250 of FIG. 2B, as discussed in reference to FIG. 2A, the initial prompt population (e.g., the first prompt population with the first-generation prompts) may be obtained.

At Operation 252, a determination is made as to whether termination criteria (e.g., the evolution termination criteria specified/included in the prompt optimization request 201) have been reached.

In the event it is determined that the termination criteria have been reached (i.e., YES in Operation 252), the process proceeds to Operation 254 where (e.g., the orchestrator engine 112) returns the best prompts selected from the initial prompt population. In this case, all of the prompts making up the initial prompt population have been deemed (as having met the termination criteria) as being optimized prompts 107.

In embodiments, any selection criteria may be used to select the best prompts from the initial prompt population. For example, the top N prompts within the initial prompt population may be selected where N may be any positive integer that is pre-defined within the orchestrator engine 112 or provided in prompt optimization request 201 as part of evolution termination criteria).

Once the best prompts have been selected in Operation 254, the process proceeds to Operation 256 where the prompt evolution process (e.g., 208, FIG. 2B) is terminated. The process (e.g., the prompt evolution process) of FIG. 2B may end following Operation 256.

Alternatively, in the event it is determined that the termination criteria have NOT been reached (i.e., NO in Operation 252; the first-generation prompts fail to meet the termination criteria), the process of FIG. 2B proceeds to Operation 258 where a new population of prompts is created while the prompt generation is increased by one generation. Namely, at this specific time of the process, a second prompt population with second-generation prompts are generated using the first-generation prompts of the first prompt population in Operation 258. The second prompt population with second-generation prompts may be generated by performing one or more genetic operators (e.g., based on the genetic operator guidelines 106, FIG. 1B) on one or more of the first-generation prompts of the first prompt population. This will be discussed in more detail in Operation 262.

Turning first to Operation 260, a determination is made as to whether a size of the new population created (e.g., generated) in Operation 258 has reached a predefined population size. This predefined population size may be defined, for example, in the evolution termination criteria specified/included in the prompt optimization request 201 and/or as a default size determined by one or more administrators of the data processing systems. The predefined population size may also be defined using other methods without departing from the scope of embodiments disclosed herein.

Because the population of a newly created generation starts of at zero (0), this initial determination at Operation 260 right after the creation of a new population/generation will also be YES. As a result, the process will proceed to Operation 262 where genetic operators may be performed on the prompts from a directly previous generation (or across multiple generations) to generate the prompts for the current population/generation that was just created (e.g., in Operation 258).

In embodiments, the population(s) evolve in an iterative fashion, where at each iteration the fitness of the individuals/prompts (in one or more previous generations) is evaluated and individuals/prompts are probabilistically selected to participate in the next iteration through the application of various genetic operators. The genetic operators are applied to combine or perturb the existing solutions with the aim of evolving a population of solutions which improve over time, according to an objective “fitness” function based on the Darwinian principles of evolution.

In embodiments, examples of the genetic operators may include: (i) selection; (ii) crossover; (iii) mutation; or any similar operators or combinations thereof.

With the selection operator, this operator is analogous to asexual reproduction in biology where an individual (here, a prompt) is copied (e.g., as-is) without modification into one or more of the next generations.

With the crossover operator, this operator is analogous to sexual reproduction/recombination in biology where parts of two individuals (here, prompts) are combined to create one or more new children, and/or offsprings (e.g., next generation prompts) that are copied into one or more of the next generations. In embodiments, the crossover operator may be performed using an LLM (e.g., the prompt evolution LLM and/or the orchestrator LLM) that is trained to combine two prompts using, for example, a natural language interface or the like. A range of different crossover guidelines may be provided (e.g., in genetic operator guidelines 106) and selected (e.g., based on the guidelines, based on the evolution termination criteria specified/included in the prompt optimization request 201, at random, or the like).

Examples of crossover guidelines (e.g., in the form of prompts) used for the crossover operator may include, but are not limited to: (i) Combine the key elements of [Prompt 1] and [Prompt 2] within the context of [Problem Context, as determined using task description or the like from prompt optimization request 201] to create a prompt to generate a comprehensive and factually accurate response; (ii) Emphasize the stronger aspects of [Prompt 1] while incorporating one or more relevant points from [Prompt 2]. After completing the response, review it to verify that the response is aligned with the provided context revise accordingly; (iii) Merge the main ideas of [Prompt 1] and [Prompt 2] within the context of [Problem Context] to form a cohesive and focused new prompt. Be Concise; (iv) Integrate the themes of [Prompt 1] and [Prompt 2] to develop a well-rounded new prompt. After completing the new prompt, modify it to remove redundant content. Ensure the resulting prompt is grammatically correct; (v) Merge the main ideas of [Prompt 1] and [Prompt 2] within the context of [Problem Context] to form a cohesive and focused new prompt. Remove duplication but ensure that all of the key details from both ideas are included; (vi) or the like.

With the mutation operator, this operator involves changing (e.g., mutating) an individual (here, a prompt) in some way and then adding the new mutated prompt into one or more of the next generations. Once the mutation operator is selected, further refinement can be introduced by selecting different levels of mutation corresponding to the degree of change to be carried out on the individual. In particular, the degree of change and the type of change (e.g., mutation) may be based on guidelines included in the genetic operator guidelines 106 and/or in the evolution termination criteria specified/included in the prompt optimization request 201. Similar to the crossover operator, the mutation operator may be performed using an LLM (e.g., the prompt evolution LLM and/or the orchestrator LLM) that is trained using, for example, a natural language interface or the like.

Examples of mutation guidelines (e.g., in the form of prompts) used for the mutation operator may include, but are not limited to: (i) Slightly rephrase [Input Prompt] to improve clarity while keeping the original meaning intact; (ii) Add a minor detail to [Input Prompt] to provide additional context without altering the main focus; (iii) Transform [Input Prompt] into a multi-part question to explore different aspects of the topic; or the like.

In embodiments, one method for selecting prompts for the next generation (e.g., for implementation of one or more genetic operators) may be a tournament selection method based on each prompt's fitness score. Using the tournament selection method, a number of prompts (within a same generation and/or different generations) may be selected to create a tournament group. A prompt within the tournament group with the highest fitness score or a number of prompts with the top M number of fitness scores may be selected (e.g., as winners of the tournament) to be moved into the next generation (e.g., by way of execution of one or more of the genetic operators on these winning prompt(s)). In this way, all prompts within a generation may have a chance of being selected and diversity is maintained within the population of prompts. Any number of tournaments may be held for each generation of prompts and each tournament may include at least three (3) (i.e., 3 or more) participants.

Although a specific method (e.g., the tournament selection method) is discussed herein as how prompts are selected for the next generation, embodiments disclosed herein are not limited to this specific tournament selection method and other types of methods for selecting prompts to be in the next generation of prompts (e.g., random selection without tournament selection, directly selecting the best P number of prompts based on the fitness scores where P may be any whole positive integer, selecting only prompts with fitness scores equal to and/or exceeding a predetermined fitness score threshold, or the like) may be used without departing from the scope of embodiments disclosed herein.

Turning back to the process of FIG. 2B, continuing with the example discussed above, once enough prompts are generated (as part of Operation 262) for the second prompt population (i.e., a YES determination at Operation 260), the process proceeds to Operation 264 where the previous generation (here, the first-generation prompts) may be discarded and only the updated (here, the second-generation prompts) are retained (e.g., used). Alternatively, instead of discarding all of the previous generation prompts, some of the previous generation prompts (here, the first-generation prompts) may be retained (e.g., based on pre-defined criteria such as the evolution termination criteria specified/included in the prompt optimization request 201, or the like) and used with all of the prompts of the updated generation (here, second-generation).

Once the updated (e.g., new) generation is established, the process returns to Operation 252 to determine whether the new generation (here, the second-generation prompts) has reached (e.g., fulfilled) the termination criteria. Said another way, Operations 252, 258, 260, 262, and 264 are repeated until it is determined (e.g., by the orchestrator engine 112 and/or the prompt evolution engines 110) that a generation/population of prompts has reached (e.g., fulfilled) the termination criteria.

Once it is determined that a generation/population of prompts has reached (e.g., fulfilled) the termination criteria, the best prompts may be selected from this generation/population (e.g., in Operation 254) and the prompt evolution terminated (e.g., in Operation 256) after this selection.

Turning back to FIG. 2A, once the optimized prompt(s) 107 (i.e., the best prompts selected in Operation 254 of FIG. 2B) are generated using prompt evolution process 208, the optimized prompt(s) 107 may be ingested into one or more downstream processes 210.

For example, the optimized prompt(s) 107 may be provided directly to a user (or a group of users) that provided the input that became the basis of the prompt optimization request 201. As another example, the optimized prompt(s) 107 may all be executed (e.g., by orchestrator engine 112, prompt evolution engine 110, or yet another trained LLM model) to generate respective responses for each of the optimized prompt(s) 107. The generated responses may then be provided (e.g., displayed on a display) to the user (or group of users) alongside each respective optimized prompt(s) 107. Other downstream processes utilizing these optimized prompt(s) 107 may also be performed without departing from the scope of embodiments disclosed herein.

Turning now to FIG. 2C, an implementation example of embodiments disclosed herein is provided. The implementation example of FIG. 2C shows one example of the prompt evolution process 208 of FIGS. 2A and 2B.

In particular, as shown in FIG. 2C, a first generation (i.e., generation 1) of prompts is obtained (e.g., as the initial prompt population 206). Generation 1 did not meet the evolution termination criteria so a new generation (i.e., generation 2) was created using the prompts in generation 1. For example, Prompt C in generation 1 was selected and the selection operator was applied to Prompt C to copy Prompt C into generation 2. As another example, Prompt G in generation 1 was selected and mutated (e.g., by the mutation operator) to obtain Prompt G′ in generation 2. Other prompts in generation 1 are also shown to be selected, crossed over, and/or mutated into generation 2 while some prompts in generation 1 were not selected and later discard.

As further shown in FIG. 2C, it is only until generation 4 that the evolution termination criteria are reached. In generation 4, only 4 prompts remain (i.e., Prompt C′BD (once mutated Prompt C crossed over with crossed over Prompt BD), Prompt F′ (once mutated Prompt F), Prompt FJ′L (one mutated crossed overed Prompt FJ crossed over with Prompt L), and Prompt K″ (twice mutated Prompt K).

From these remaining four (4) prompts, a number of best prompts will be selected for downstream use as the optimized prompt(s) 107. As shown here in generation 4, none of the original prompts from generation 1 remained. Thus, the assumption here is that the resulting prompts in generation 4 are improved/optimized (e.g., through evolution) versions of the original prompts from generation 1.

Any of the processes illustrated using the second set of shapes (shown in FIG. 2A) may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

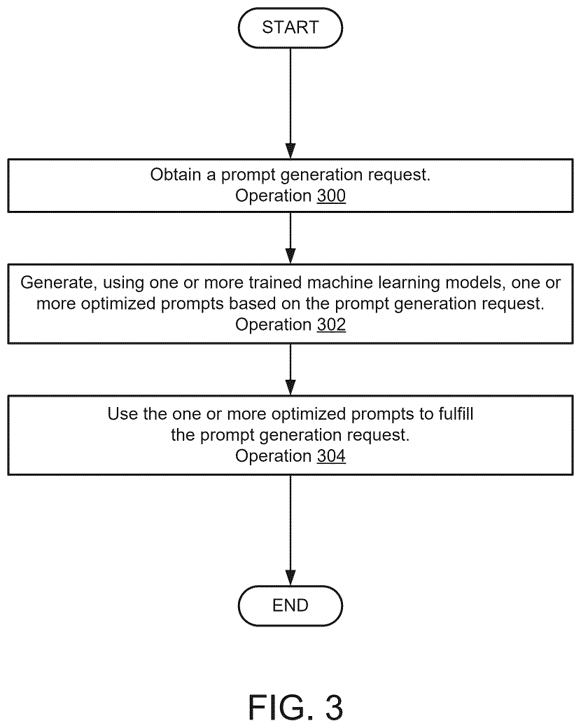

As discussed above, the components of FIGS. 1A-2C may perform various methods for machine generated data conversion using an on-device idle NPU resource utilization process. FIG. 3 illustrates an example of a method that may be performed by the components of FIGS. 1A-2C. For example, any of the data processing systems 101A-101N may perform all or a portion of the methods. In the diagrams discussed below and shown in FIG. 3, any of the operations may be repeated, performed in different orders, and/or performed in parallel with or in a partially overlapping in time manner with other operations. Additionally, the process depicted in the flowchart of FIG. 3 may be performed using idle NPU resources of one or more NPU(s) hosted by a data processing system.

Starting at Operation 300 of FIG. 3, as discussed above in reference to FIGS. 2A-2B, a prompt optimization request (e.g., 201 of FIG. 2A) may be obtained.

At Operation 302, and as discussed above in reference to FIGS. 2A-2C, one or more optimized responses (e.g., 107, FIGS. 1B and 2A) may be generated (e.g., obtained) based on the prompt optimization request using one or more trained machine learning models (e.g., 110 and 112, FIGS. 1B and 1C).

At Operation 304, and as discussed above in reference to FIGS. 2A-2C, the one or more optimized prompts may be used to fulfill the prompt generation request. For example, the optimized prompt(s) may be provided directly to a user (or a group of users) that provided the input that became the basis of the prompt optimization request. As another example, the optimized prompt(s) may all be executed (e.g., by orchestrator engine, prompt evolution engine, or yet another trained LLM model) to generate respective responses for each of the optimized prompt(s). The generated responses may then be provided (e.g., displayed on a display) to the user (or group of users) alongside each respective optimized prompt(s). Other downstream processes utilizing these optimized prompt(s) may also be performed to fulfill the prompt generation request without departing from the scope of embodiments disclosed herein.

The process of FIG. 3 may end following Operation 304.

Although embodiments disclosed herein have been described using a local, on-device/intranet setting, they are not limited to such a configuration. Namely, embodiments disclosed herein may also be applied to a network setting where idle NPU resources are shared (e.g., rented, sold, used in cooperatively, or the like) between data processing systems of different environments (e.g., 100, FIG. 1A) separated by the network (e.g., communication system 104 of FIG. 1A). For example, the idle NPU resources of data processing systems 101A-101N of environment 100 may be shared (e.g., rented out, shared with, used cooperatively with, sold to, etc.) with any of the other data processing systems 102 that are separated from environment 100 by communication system 104. Said another way, the idle NPU resources of environment 100 may be provided to the other data processing system 102 in an as-a-service (aaS) manner, similar to a digital idle NPU resource marketplace setting.

Additionally, although idle NPU resources are specifically mentioned herein, embodiments disclosed herein are not limited to the use of these idle resources. More specifically, non-idle resources of NPUs (and/or even idle and/or non-idle resources of CPUs and GPUs of the data processing system) may also be used without departing from the scope of this invention. Other types of processing units (e.g., data processing units (DPUs), language processing unit (LPU), tensor processing units (TPUs), or the like) may also be used to execute the processes and methods of embodiments discussed herein.

Furthermore, although LLMs are specifically mentioned throughout this disclosure, one having ordinary skill in the art would appreciate that any other types of generative AI models (e.g., multi-modal models that handle text, images, and videos; generative adversarial networks (GANs); or the like) may also be used instead of LLMs without departing from the scope of embodiments disclosed herein.

Even further, although the evolutionary process (combining LLM with EC techniques) is applied to prompt generation and optimization, embodiments disclosed herein is not limited to this specific example. In particular, the evolutionary process of embodiments disclosed herein may also be applied to other types of optimization based tasks other than prompt optimization, especially types of optimization based tasks where meta heuristics can deliver acceptable results.

Any of the components illustrated in FIGS. 1A-3 may be implemented with one or more computing devices. Turning to FIG. 4, a block diagram illustrating an example of a computing device (also referred to herein as “system 400”) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system-on-a-chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth® transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for generating optimized prompts, the method comprising:
obtaining a first prompt optimization request comprising a first task description and a first evolution termination criteria;
causing one or more trained machine learning models to generate a first prompt population for the first prompt optimization request, the first prompt population for the first prompt optimization request comprising first-generation prompts based on the first task description and each of the first-generation prompts comprising a prompt fitness score;
making a first determination that the first prompt population for the first prompt optimization request fails to meet the first evolution termination criteria;
performing, in response to the first determination, a prompt evolution process on the first prompt population for the first prompt optimization request to obtain a second prompt population for the first prompt optimization request, the second prompt population for the first prompt optimization request comprising second-generation prompts based on the first-generation prompts and each of the second-generation prompts comprises the prompt fitness score;
making a second determination that the second prompt population for the first prompt optimization request meets the first evolution termination criteria;
selecting, in response to the second determination, at least one of the second-generation prompts of the second prompt population for the first prompt optimization request as an optimized prompt for the first prompt optimization request; and
using the optimized prompt for the first prompt optimization request to fulfill the first prompt optimization request.

2. The method of claim 1, further comprising:
obtaining a second prompt optimization request comprising a second task description and a second evolution termination criteria;
causing the one or more trained machine learning models to generate the first prompt population for the second prompt optimization request, the first prompt population for the second prompt optimization request comprising first-generation prompts based on the second task description and each of the first-generation prompts comprising the prompt fitness score;
making a third determination that the first prompt population for the second prompt optimization request meets the second evolution termination criteria;
selecting, in response to the third determination, at least one of the first-generation prompts of the first prompt population for the second prompt optimization request as an optimized prompt for the second prompt optimization request; and
using the optimized prompt for the second prompt optimization request to fulfill the first prompt optimization request.

3. The method of claim 1, wherein the first prompt population of the first prompt optimization request is generated using idle neural processing unit (NPU) resources of one or more data processing systems on which the one or more trained machine learning models are respectively hosted, the idle NPU resources are associated with at least one NPU of each of the one or more data processing systems, and the at least one NPU of each of the data processing systems is separate from a central processing unit (CPU) of each of the data processing systems.

4. The method of claim 1, wherein the method is performed using idle neural processing unit (NPU) resources of one or more data processing systems on which the one or more trained machine learning models are respectively hosted, the idle NPU resources are associated with at least one NPU of each of the one or more data processing systems, and the at least one NPU of each of the data processing systems is separate from a central processing unit (CPU) of each of the data processing systems.

5. The method of claim 4, wherein performing the prompt evolution process on the first prompt population comprises:
selecting at least one of the first-generation prompts based on the prompt fitness score of the at least one of the first-generation prompts that is selected; and
performing a genetic operation on the at least one of the first-generation prompts that is selected to obtain at least one of the second-generation prompts.

6. The method of claim 5, wherein the genetic operation comprises a direct selection of the at least one of the first-generation prompts to be used as-is as the at least one of the second-generation prompts that is obtained.

7. The method of claim 5, wherein the genetic operation comprises a mutation of at least one portion of the at least one of the first-generation prompts into the at least one of the second-generation prompts.

8. The method of claim 5, wherein the genetic operation comprises a crossover of the at least one of the first-generation prompts with another one of the first-generation prompts to obtain the at least one of the second-generation prompts as an offspring of the at least one of the first-generation prompts and the other one of the first-generation prompts.

9. The method of claim 5, wherein instances of the genetic operation are performed repeatedly on different ones of the first-generation prompts until a predetermined population number is reached for the second prompt population for the first prompt optimization.

10. The method of claim 4, wherein using the optimized prompt for the first prompt optimization request to fulfill the first prompt optimization request comprises:
ingesting the optimized prompt for the first prompt optimization request into at least one of the one or more trained machine learning models to generate a query response based on the optimized prompt for the first prompt optimization request, the query response being responsive to a query input by a user and the first prompt optimization request being generated based on the query; and
providing the query response to the user along with the optimized prompt for the first prompt optimization request.

11. A non-transitory machine-readable medium having instructions stored therein, which when executed by a processor, cause the processor to perform operations for generating optimized prompts, the operations comprising:
obtaining a first prompt optimization request comprising a first task description and a first evolution termination criteria;
causing one or more trained machine learning models to generate a first prompt population for the first prompt optimization request, the first prompt population for the first prompt optimization request comprising first-generation prompts based on the first task description and each of the first-generation prompts comprising a prompt fitness score;
making a first determination that the first prompt population for the first prompt optimization request fails to meet the first evolution termination criteria;
performing, in response to the first determination, a prompt evolution process on the first prompt population for the first prompt optimization request to obtain a second prompt population for the first prompt optimization request, the second prompt population for the first prompt optimization request comprising second-generation prompts based on the first-generation prompts and each of the second-generation prompts comprises the prompt fitness score;
making a second determination that the second prompt population for the first prompt optimization request meets the first evolution termination criteria;
selecting, in response to the second determination, at least one of the second-generation prompts of the second prompt population for the first prompt optimization request as an optimized prompt for the first prompt optimization request; and
using the optimized prompt for the first prompt optimization request to fulfill the first prompt optimization request.

12. The non-transitory machine-readable medium of claim 11, wherein the operations further comprise:
obtaining a second prompt optimization request comprising a second task description and a second evolution termination criteria;
causing the one or more trained machine learning models to generate the first prompt population for the second prompt optimization request, the first prompt population for the second prompt optimization request comprising first-generation prompts based on the second task description and each of the first-generation prompts comprising the prompt fitness score;
making a third determination that the first prompt population for the second prompt optimization request meets the second evolution termination criteria;
selecting, in response to the third determination, at least one of the first-generation prompts of the first prompt population for the second prompt optimization request as an optimized prompt for the second prompt optimization request; and
using the optimized prompt for the second prompt optimization request to fulfill the first prompt optimization request.

13. The non-transitory machine-readable medium of claim 11, wherein the first prompt population of the first prompt optimization request is generated using idle neural processing unit (NPU) resources of one or more data processing systems on which the one or more trained machine learning models are respectively hosted, the idle NPU resources are associated with at least one NPU of each of the one or more data processing systems, and the at least one NPU of each of the data processing systems is separate from a central processing unit (CPU) of each of the data processing systems.

14. The non-transitory machine-readable medium of claim 11, wherein the operations are performed using idle neural processing unit (NPU) resources of one or more data processing systems on which the one or more trained machine learning models are respectively hosted, the idle NPU resources are associated with at least one NPU of each of the one or more data processing systems, and the at least one NPU of each of the data processing systems is separate from a central processing unit (CPU) of each of the data processing systems.

15. The non-transitory machine-readable medium of claim 14, wherein performing the prompt evolution process on the first prompt population comprises:
selecting at least one of the first-generation prompts based on the prompt fitness score of the at least one of the first-generation prompts that is selected; and
performing a genetic operation on the at least one of the first-generation prompts that is selected to obtain at least one of the second-generation prompts.

16. A data processing system comprising:
a central processing unit (CPU); and
a memory coupled to the CPU to store instructions, which when executed by the CPU, cause the CPU to perform operations for generating optimized prompts, the operations comprising:
obtaining a first prompt optimization request comprising a first task description and a first evolution termination criteria;
causing one or more trained machine learning models to generate a first prompt population for the first prompt optimization request, the first prompt population for the first prompt optimization request comprising first-generation prompts based on the first task description and each of the first-generation prompts comprising a prompt fitness score;
making a first determination that the first prompt population for the first prompt optimization request fails to meet the first evolution termination criteria;
performing, in response to the first determination, a prompt evolution process on the first prompt population for the first prompt optimization request to obtain a second prompt population for the first prompt optimization request, the second prompt population for the first prompt optimization request comprising second-generation prompts based on the first-generation prompts and each of the second-generation prompts comprises the prompt fitness score;
making a second determination that the second prompt population for the first prompt optimization request meets the first evolution termination criteria;
selecting, in response to the second determination, at least one of the second-generation prompts of the second prompt population for the first prompt optimization request as an optimized prompt for the first prompt optimization request; and
using the optimized prompt for the first prompt optimization request to fulfill the first prompt optimization request.

17. The data processing system of claim 16, wherein the operations further comprise:
obtaining a second prompt optimization request comprising a second task description and a second evolution termination criteria;
causing the one or more trained machine learning models to generate the first prompt population for the second prompt optimization request, the first prompt population for the second prompt optimization request comprising first-generation prompts based on the second task description and each of the first-generation prompts comprising the prompt fitness score;
making a third determination that the first prompt population for the second prompt optimization request meets the second evolution termination criteria;
selecting, in response to the third determination, at least one of the first-generation prompts of the first prompt population for the second prompt optimization request as an optimized prompt for the second prompt optimization request; and
using the optimized prompt for the second prompt optimization request to fulfill the first prompt optimization request.

18. The data processing system of claim 16, wherein the first prompt population of the first prompt optimization request is generated using idle neural processing unit (NPU) resources of one or more data processing systems on which the one or more trained machine learning models are respectively hosted, the idle NPU resources are associated with at least one NPU of each of the one or more data processing systems, and the at least one NPU of each of the data processing systems is separate from a central processing unit (CPU) of each of the data processing systems.

19. The data processing system of claim 16, wherein the operations are performed using idle neural processing unit (NPU) resources of one or more data processing systems on which the one or more trained machine learning models are respectively hosted, the idle NPU resources are associated with at least one NPU of each of the one or more data processing systems, and the at least one NPU of each of the data processing systems is separate from a central processing unit (CPU) of each of the data processing systems.

20. The data processing system of claim 19, wherein performing the prompt evolution process on the first prompt population comprises:
selecting at least one of the first-generation prompts based on the prompt fitness score of the at least one of the first-generation prompts that is selected; and
performing a genetic operation on the at least one of the first-generation prompts that is selected to obtain at least one of the second-generation prompts.
